(19) United States
(12) Patent Application Publication
(10) Pub. No.: US 2005/0049858 A1
(43) Pub. Date: Mar. 3, 2005

(54) Methods and systems for improving alphabetic speech recognition accuracy

(75) Inventor: Senis Busayapongchai, Tucker, GA (US)

Correspondence Address: BELLSOUTH CORPORATION, P.O. BOX 2903, MINNEAPOLIS, MN, 55402-0903, US

(73) Assignee: BellSouth Intellectual Property Corporation

(21) Appl. No.: 10/647,611

(22) Filed: Aug. 25, 2003

(51) Int. Cl. G10L 15/00

(52) U.S. Cl. 704/231

(57) ABSTRACT

Methods and systems are provided for improving the accuracy of a speech recognition system in recognizing alphabetic character input. If spoken alphabetic characters are erroneously recognized by a speech recognition system, a user may reenter the alphabetic characters using DTMF key tones on the user's telephone keypad to assist the speech recognition system in determining the correct input. If the input is originally input using DTMF key tones, the user may reenter the input as spoken alphabetic characters to assist the system to identify the correct input from the combinations of input that may be associated with the DTMF key tone entry.

### FIELD OF THE INVENTION

The present invention relates to systems and methods for recognizing and processing human speech. More particularly, the present invention relates to a method and system for improving alphabetic speech recognition by a speech recognition engine.

### BACKGROUND OF THE INVENTION

With the advent of modern telecommunications systems a variety of voice-based systems have been developed to reduce the costly and inefficient use of human operators. For example, a caller to a place of business may be routed to an interactive voice application via a computer telephony interface where spoken words from the caller may be recognized and processed in order to assist the caller with her needs. A typical voice application session includes a number of interactions between the user (caller) and the voice application system. The system may first play one or more voice prompts to the caller to which the caller may respond. A speech recognition engine recognizes spoken words from the caller and passes the recognized words to an appropriate voice application. For example, if the caller speaks “transfer me to Mr. Jones please,” the speech recognition engine must recognize the spoken words in order for the voice application, for example a voice-based call processing application, to transfer the caller as requested.

Often, users or callers are required by voice application systems to speak one or more alphabetic characters. For example, a voice application may provide a prompt to a user such as “please spell your last name.” Unfortunately, many alphabetic characters such as “B,” “D,” and “E,” sound very similar, and consequently, speech recognition engines often incorrectly recognize such spoken alphabetic characters. Systems have been developed for improving the understanding of spoken alphabetic characters. For example, the NATO phonetic alphabet including the characters “alpha, bravo, charlie, . . . zulu” was developed in the 1950's to improve the understanding of spoken alphabetic characters over radio transmissions. Unfortunately, callers or users of voice-based applications often speak alphabetic characters non-phonetically, phonetically, or users may use combinations of phonetic and non-phonetic pronunciations. Additionally, some users or callers utilize a telephone keypad to enter alphabetic characters, but because each key of a telephone keypad is associated with more than one alphabetic character, it is often difficult for voice applications to identify the precise alphabetic character or combination of alphabetic characters entered by a user from the potential permutations of characters possible from the collection of one or more keys from a telephone keypad.

Accordingly, there is a need for a method and system for enhancing the accuracy of a speech recognition system in recognizing alphabetic character input. It is with respect to these and other considerations that the present invention has been made.

### SUMMARY OF THE INVENTION

Embodiments of the present invention solve the above and other problems by providing a method and system for enhancing the accuracy of a speech recognition system in recognizing alphabetic character input. According to an aspect of the invention, alphabetic characters are input by a user either by speaking the alphabetic characters or by selection of DTMF keys on a user's telephone keypad. The alphabetic characters entered by the user are processed by a speech recognition engine, and the results are presented back to the user for verification. If the user entered the characters by speaking the alphabetic characters, and the results of the speech recognition engine are not verified by the user, the user is requested to re-enter the spoken characters by DTMF key selection.

A determination is made as to the number of different corresponding character strings that are possible from the DTMF selection and that sound like the original alphabetic input provided by the user. If only one DTMF string sounds like the original input provided by the user, that string is presented to the user for verification. If more than one possible DTMF string sounds like the original input from the user, then the user is requested to repeat the alphabetic input. The speech recognition engine analyzes the repeated alphabetic input and attempts to match the repeated alphabetic character input to one of the DTMF strings in order to narrow the possible DTMF strings to the correct string of alphabetic characters. The speech recognition engine selects one of the DTMF strings by comparison to the repeated alphabetic character input and verifies the selected string with the user. If the string is verified by the user, the string is designated as the proper alphabetic characters required by the user. If not, the user is sent to a human operator to determine the proper alphabetic character input.

According to another aspect, if the user originally inputs the alphabetic characters by DTMF selection, and the DTMF selection presented back to the user is not verified by the user, a determination is made as to a combination of potential character strings that may be presented based on the DTMF key selection made by the user. The user is then requested to reenter the character input by speaking the alphabetic characters into the system. The speech recognition engine then analyzes the spoken alphabetic characters and compares the results of the analyzed spoken alphabetic characters with the DTMF strings presented from the DTMF key selection made by the user. If one of the DTMF entered character strings is matched to the voice entered alphabetic character string, that character string is presented to the user for verification. If the user verifies the character string as the correct character string, that character string is designated as the correct input from the user. If not, the user is sent to a human operator to provide the alphabetic character input.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a simplified block diagram illustrating interaction between a wireless or wireline telephony system and an intelligent interactive voice response system according to embodiments of the present invention.

FIG. 2 is a simplified block diagram illustrating interaction between hardware and software components of an interactive voice system according to embodiments of the present invention.

FIGS. 3 and 4 illustrate a logical flow of steps performed by a method and system of the present invention for increasing alphabetic speech recognition system accuracy.

### DETAILED DESCRIPTION OF THE PREFERRED EMBODIMENT

As briefly described above, embodiments of the present invention provide methods and systems for improving the accuracy of a speech recognition system in recognizing alphabetic character input. If spoken alphabetic characters are erroneously recognized by a speech recognition system, a user may reenter the alphabetic characters using the user's telephone keypad to assist the speech recognition system in determining the correct input. If the input is originally input using the user's telephone keypad, for example DTMF key tones, the user may reenter the input as spoken alphabetic characters to assist the system to identify the correct input from the combinations of input that may be associated with the DTMF key tone entry. The embodiments of the present invention described herein may be combined, other embodiments may be utilized, and structural changes may be made without departing from the spirit and scope of the present invention. The following detailed description is, therefore, not to be taken in the limiting sense, and the scope of the present invention is defined by the pending claims and their equivalents. Referring now to the drawings, in which like numerals refer to like components or like elements throughout the several figures, aspects of the present invention and an exemplary operating environment will be described.

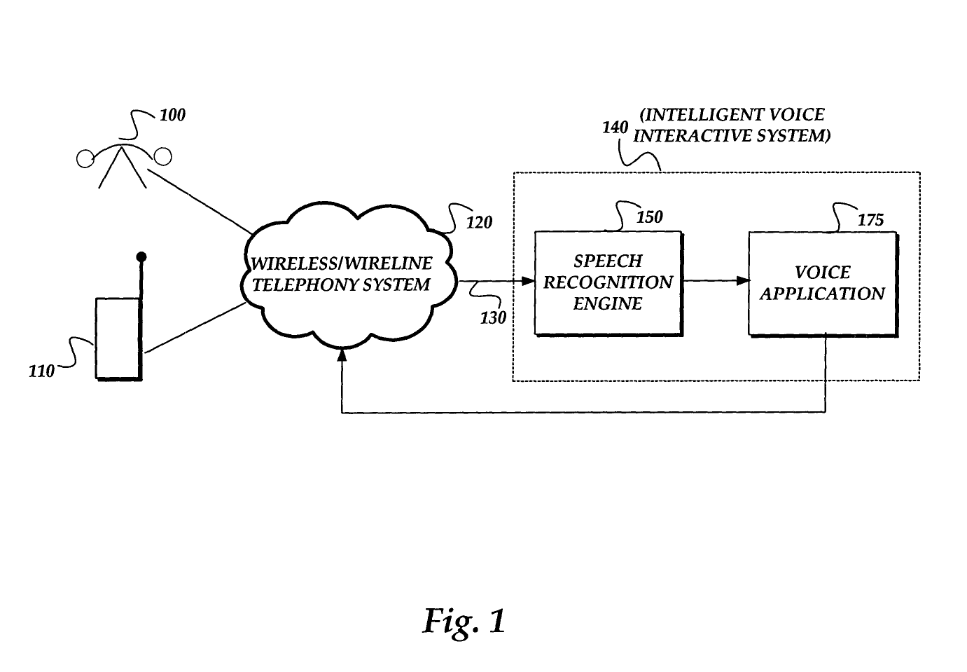

FIG. 1 and the following description are intended to provide a brief and general description of a suitable operating environment in which embodiments of the present invention may be implemented. FIG. 1 is a simplified block diagram illustrating interaction between a wireless or wireline telephony system and an interactive voice system according to embodiments of the present invention.

A typical operating environment for the present invention includes an interactive voice system 140 through which an interactive voice communication may be conducted between a human caller and a computer-implemented voice application 175. The interactive voice system 140 is illustrative of a system that may receive voice input from a caller and convert the voice input to data for processing by a general purpose computing system in order to provide service or assistance to a caller or user. Interactive voice systems 140 are typically found in association with wireless and wireline telephony systems 120 for providing a variety of services such as directory assistance services and general call processing services. Alternatively, interactive voice systems 140 may be maintained by a variety of other entities such as businesses, educational institutions, leisure activities centers, and the like for providing voice response assistance to callers. For example, a department store may operate a interactive voice system 140 for receiving calls from customers and for providing helpful information to customers based on voice responses by customers to prompts from the interactive voice system 140. For example, a customer may call the interactive voice system 140 of the department store and may be prompted with a statement such as “welcome to the department store—may I help you?” If the customer responds “please transfer me to the shoe department,” the interactive voice system 140 will attempt to recognize and process the statement made by the customer and transfer the customer to the desired department.

The interactive voice system 140 may be implemented with multi-purpose computing systems and memory storage devices for providing advanced voice-based telecommunications services as described herein. According to an embodiment of the present invention, the interactive voice system 140 may communicate with a wireless/wireline telephony system 120 via ISDN lines 130. The line 130 is also illustrative of a computer telephony interface through which voice prompts and voice responses may be passed to the general-purpose computing systems of the interactive voice system 140 from callers or users through the wireless/wireline telephony system 120. The interactive voice system also may include DTMF signal recognition devices, speech recognition, tone generation devices, text-to-speech (TTS) voice synthesis devices and other voice or data resources.

As illustrated in FIG. 1, a speech recognition engine 150 is provided for receiving voice input from a caller connected to the interactive voice system 140 via the wireless/wireline telephony system 120. According to embodiments of the present invention, if the voice input from the caller is analog, the telephony interface component in the interactive voice system converts the voice input to digital. Then, the speech recognition engine 150 analyzes and attempts to recognize the voice input. Alternatively, if the voice input is in a digital format, no analog to digital conversion is necessary before sending the input to the speech recognition engine 150. As understood by those skilled in the art, speech recognition engines use a variety of means for recognizing spoken utterances. For example, the speech recognition may analyze phonetically the spoken utterance passed to it to attempt to construct a digitized spelled word or phrase from the spoken utterance.

Once the speech recognition engine recognizes a voice input, data representing the voice input may be processed by a voice application 175 operated by a general computing system. The voice application 175 is illustrative a variety of software applications containing sufficient computer executable instructions which when executed by a computer provide services to a caller or a user based on digitized voice input from the caller or user passed through the speech recognition engine 150.

In a typical operation, a voice input is received by the speech recognition engine 150 from a caller via the wireless/wireline telephony system 120 requesting some type of service, for example general call processing or other assistance. Once the initial request is received by the speech recognition engine 150 and is passed as data to the voice application 175, a series of prompts may be provided to the user or caller to request additional information from the user or caller. Each responsive voice input by the user or caller is recognized by the speech recognition engine 150 and is passed to the voice application 175 for processing according to the request or response from the user or caller. Canned responses to the caller may be provided by the voice application 175 or responses may be generated by the voice application 175 on the fly by obtaining responsive information from a memory storage device followed by a conversion of the responsive information from text-to-speech, followed by playing the text-to-speech response to the caller or user.

According to embodiments of the present invention, the interactive voice system 140 may be operated as part of an intelligent network component of a wireless and wireline telephony system 120. As is known to those skilled in the art, modem telecommunications networks include a variety of intelligent network components utilized by telecommunications services providers for providing advanced functionality to subscribers. For example, according to embodiments of the present invention the interactive voice system 140 may be integrated with a services node/voice services node (not shown) or voice mail system (not shown). Services nodes/voice services nodes are implemented with multi-purpose computing systems and memory storage devices for providing advanced telecommunications services to telecommunication services subscribers. In addition to the computing capability and database maintenance features, such services nodes/voice services nodes may include DTMF signal recognition devices, voice recognition devices, tone generation devices, text-to-speech (TTS), voice synthesis devices and other voice or data resources.

The interactive voice system 140 operating as a stand alone system, as illustrated in FIG. 1, or operating via an intelligent network component, such as a services node or a voice services node, may be implemented as a packet-based computing system for receiving packetized voice and data communications. Accordingly, the computing systems and software of the interactive voice system 140 or services nodes/voice services node may be communicated with via voice and data over Internet Protocol from a variety of digital data networks such as the Internet and from a variety of telephone and mobile digital devices 100, 110.

The wireless/wireline telephony system 120 is illustrative of a wired public switched telephone network accessible via a variety of wireline devices such as the wireline telephone 100. The telephony system 120 is also illustrative of a wireless network such as a cellular telecommunications network and may comprise a number of wireless network components such as mobile switching centers for connecting communications from wireless subscribers from wireless telephones 110 to a variety of terminating communications stations. A should be understood by those skilled in the art, the wireless/wireline telephony system 120 is also illustrative of other wireless connectivity systems including ultra wideband and satellite transmission and reception systems where the wireless telephone 110 or other mobile digital devices, such as personal digital assistants, may send and receive communications directly through varying range satellite transceivers.

As illustrated in FIG. 1, the telephony devices 100 and 110 may communicate with an interactive voice system 140 via the wireless/wireline telephony system 120. The telephones 100 and 110 may also connect through a digital data network such as the Internet via a wired connection or via wireless access points to allow voice and data communications. For purposes of the description that follows, communications to and from any wireline or wireless telephone unit 100, 110 includes, but is not limited to, telephone devices that may communicate via a variety of connectivity sources including wireline, wireless, voice and data over Internet protocol, wireless fidelity (WIFI), ultra wideband communications and satellite communications. Mobile digital devices, such as personal digital assistants, instant messaging devices, voice and data over Internet protocol devices, communication watches or any other devices allowing digital and/or analog communication over a variety of connectivity means may be utilized for communications via the wireless and wireline telephony system 120.

While the invention may be described in general context of software program modules that execute in conjunction with an application program that runs on an operating system of a computer, those skilled in the art will recognize that the invention may also be implemented in a combination of other program modules.

Generally, program modules include routines, programs, components, data structures and other types of structures that perform particular tasks or implement particular abstract data types. Moreover, those skilled in the art will appreciate that the invention may be practiced with other telecommunications systems and computer systems configurations, including hand-held devices, multi-processor systems, multi-processor based or programmable consumer electronics, mini computers, mainframe computers, and the like. The invention may also be practiced in a distributed computing environment where tasks are performed by remote processing devices that are linked through a communications network. In a distributing computing environment, program 10 modules may be located in both local and remote memory sources devices.

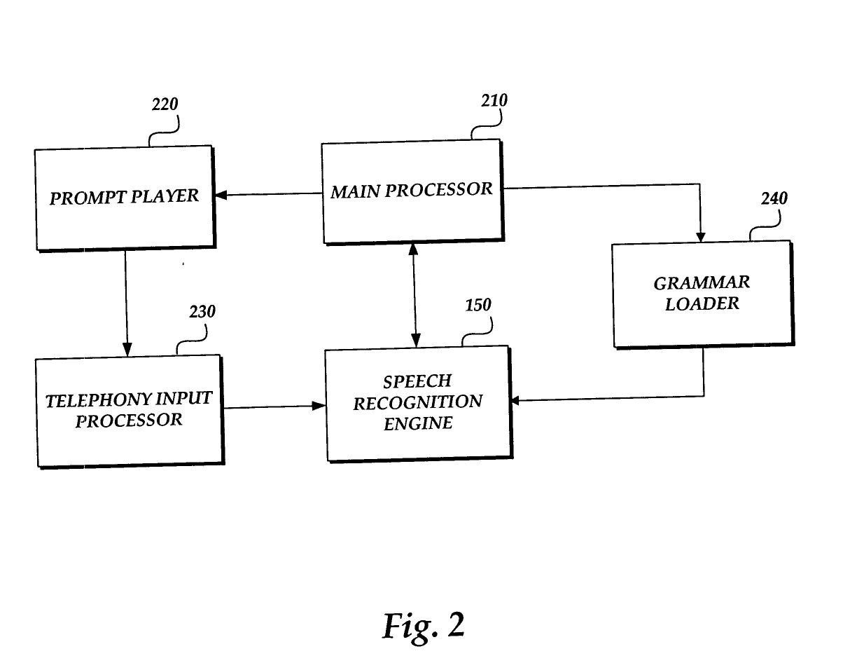

FIG. 2 is a simplified block diagram illustrating interaction between hardware and software components of an interactive voice system according to embodiments of the present invention. The components illustrated in FIG. 2 are utilized in accordance with embodiments of the present invention for using keypad input, such as DTMF character entry, to augment or enhance a speech recognition engine's ability to accurately recognize spoken alphabetic character entry. According to embodiments of the present invention, the components illustrated in FIG. 2 are illustrative of software modules having sufficient computer executable instructions which when executed by a computer perform the functions described herein according to embodiments of the present invention.

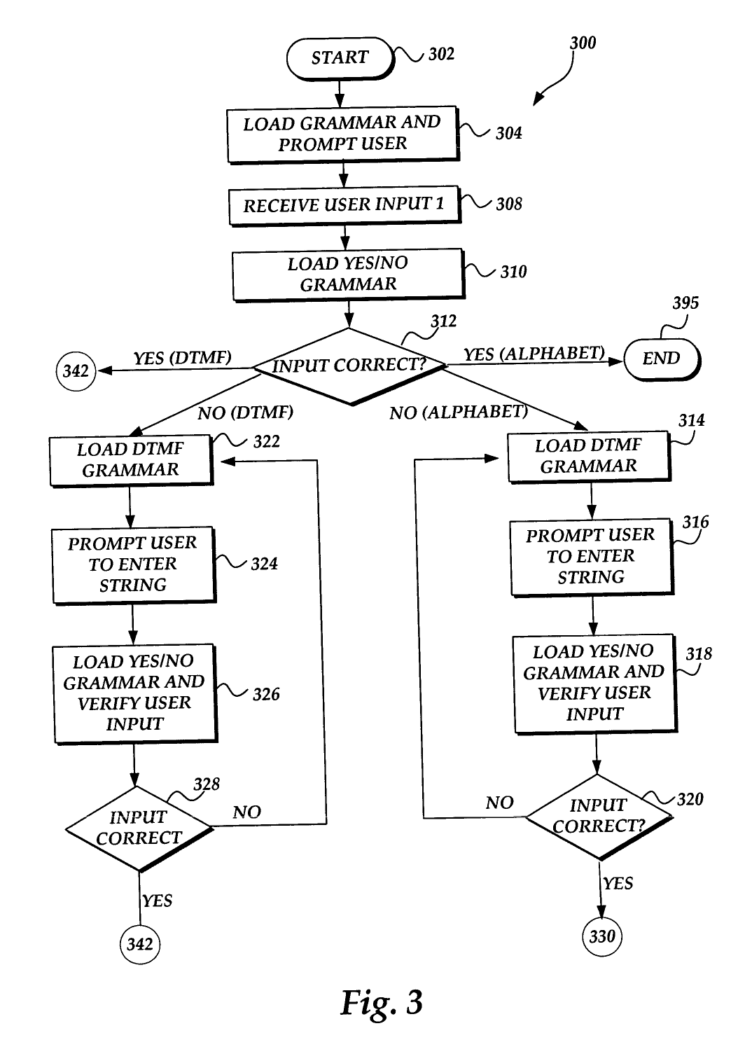

As will be described in further detail below with respect to FIG. 3, when a user is requested to enter alphabetic character input by the interactive voice system 140 described above, a main processor 210 of the interactive voice system 140 directs the prompt player module 220 to provide voice prompts to the user via the wireless/wireline telephony system 120 in order to commence a voice interactive session with the user. In response, the prompt player module directs the telephony input processor 230 to play selected audio prompts to the user as requested by the prompt player module. If the telephony input processor detects that the user has provided voice or speech input, the telephony input processor interrupts the prompt and streams the audio input from the user to the speech recognition engine 150.

The speech recognition engine 150 accepts the user audio input stream and recognizes the input based on loaded grammar. For example, if the user is requested to input alphabetic characters, grammar utilized by the speech recognition engine 150 for recognizing the audio input from the user will be grammar allowing the speech recognition engine to recognize alphabetic input such as “A, B, C,” etc. Phonetic alphabet input such as “alpha, bravo, charlie,” etc., keypad entry, including DTMF character input, such as “2, 3, 4” to represent the characters “B, E, H,” and/or a combination of the above. The grammar loader module 240 prepares the grammar according to the direction of the main processor in relation to the voice information requested by the main processor, as described above. The grammar loader activates the speech recognition engine 150 with the requested grammar.

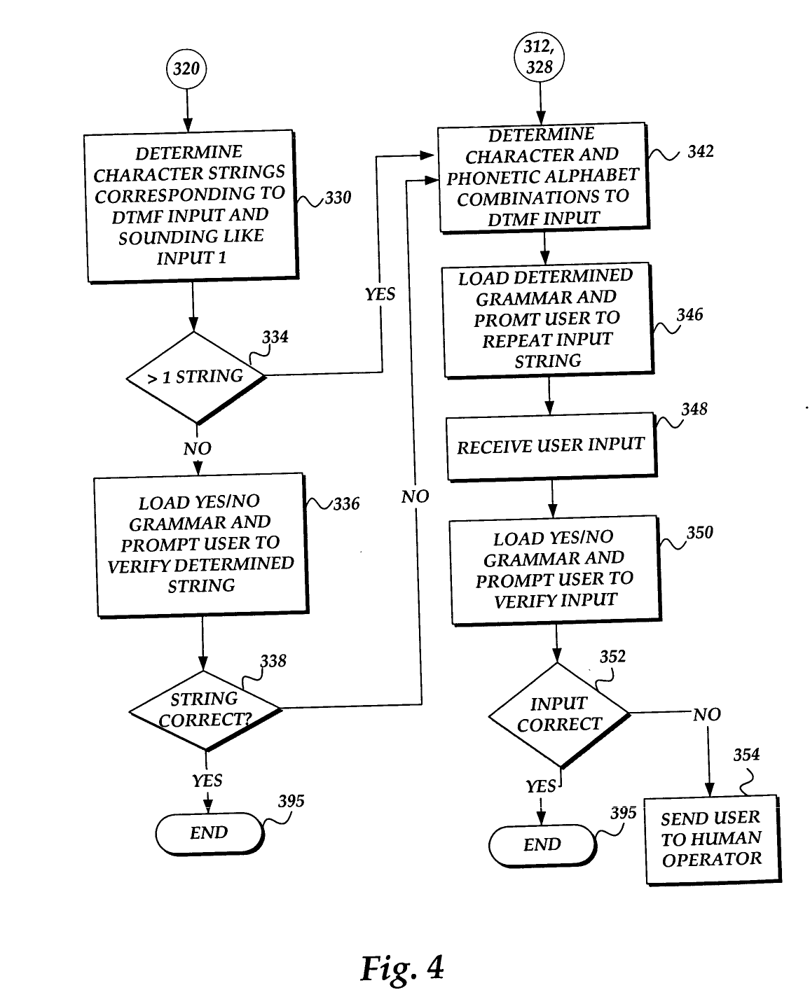

Having described an exemplary operating environment and system architecture for the present invention with respect to FIGS. 1 and 2, it is advantageous to describe the functionality of the present invention with respect to a logical flow of steps performed by a method and system of the present invention for improving alphabetic character speech recognition accuracy using keypad entry, including DTMF character entry, to augment a speech recognition engine's ability to recognize and process alphabetic character input. Referring then to FIGS. 3 and 4, the method 300 begins at start block 302 and proceeds to block 304 where a main processor 210 of an interactive voice system 140 at the direction of a voice application 175 requests a user to enter alphabetic characters. For example, the voice application 175 may be a telephone system directory services application that may direct the main processor 210 to request the user to spell the user's last name by entry of alphabetic characters.

At block 304, the main processor 210 directs the grammar loader 240 to load a general grammar set for accepting alphabetic character entry. According to one embodiment of the present invention, an example grammar set for entry alphabetic characters will accept a combination of non-phonetic and phonetic alphabetic characters. The exemplary grammar set will also accept keypad entries, including DTMF numbers corresponding to alphabetic characters. For example, the general grammar set will allow non phonetic character input such as “A, B, C, . . . Z.” The grammar set likewise will allow phonetic character entry including “alpha, bravo, charlie, . . . Zulu.” The general grammar set will also allow a series of numeric characters such as “2” to represent the characters “A, B, C,” etc. As is understood by those skilled in the art, DTMF character entry allows a user to utilize keys from a standard telephone keypad to enter one or more alphabetic characters. However, because the numbers “2” through “9” are associated with multiple alphabetic characters, a determination must be made as to what alphabetic character is associated with a given keypad entry.

According to embodiments of the present invention, the general grammar set described herein will also accept a combination of characters and phonetic alphabetic characters such as “A, B, charlie, and delta.” As should be understood by those skilled in the art, the phonetic alphabetic system described herein is typical of one phonetic alphabetic system, but is not restrictive of other phonetic alphabetic systems that may be used and integrated with the general grammar set and utilized according to embodiments of the present invention.

Continuing with the description of FIGS. 3 and 4, at block 304, the main processor directs the prompt player module 220 and the telephony input processor 230 to prompt the user for alphabetic character input. For example, the user may be prompted to spell the user's last name by speaking alphabetic characters or by entering characters using the user's telephone keypad. At block 308, the telephony input processor 230 receives the alphabetic character input from the user and passes the input to the speech recognition engine 150. The speech recognition engine 150 converts the analog voice or speech input from the user to a digital data representation of the input for processing by the voice application 175. The speech recognition engine then attempts to recognize the spoken alphabetic characters entered by the user.

At block 310, the main processor directs the grammar loader to load a yes/no grammar and directs the prompt player to play the output from the speech recognition engine 150 back to the user. The prompt player then asks the user to verify that the output from the speech recognition engine 150 is correct. That is, if the user entered alphabetic characters such as “J, 0, N, E and S” to spell the name “Jones,” the speech recognition engine will digitize the voice input from the user and generate a digital output. The output is played back to the user by the prompt player to ask the user if the output is correct. At block 312, if the user entered the characters by voice alphabetic character input and the output from the speech recognition engine 150 is correct, the method proceeds to block 395 and ends.

If the output from the speech recognition engine is not correct, an indication is received that the speech recognition engine 150 had difficulty recognizing the alphabetic characters input by the user. For example if the speech recognition engine causes the characters “J, O, N, D, S” back to the user, the user will not verify the accuracy of the playback because the speech recognition engine erroneously recognized the input character of “E” as “D.” Accordingly, the method proceeds to block 314, and the speech recognition engine 150 utilizes keypad input, such as DTMF character input, to augment its ability to recognize the alphabetic characters input from the user.

At block 314, the main processor 210 directs the grammar loader to load a keypad character input grammar, such as a DTMF character input grammar, if not already loaded, so that the speech recognition engine will recognize characters input by the user using the keypad entry, such as DTMF characters of the user's telephone keypad. As should be understood, non-DTMF keypad systems such as those associated with wireless telephone devices may be used so long as a grammar associated with keypad entry from the non-DTMF keypad systems is loaded to allow such keypad entry to be associated with the alphabetic entry entered by the user. That is, keypad entry from non-DTMF devices may be utilized in accordance with embodiments of the present invention so long as a grammar associated with the non-DTMF devices is loaded to associate keypad entries from the non-DTMF devices with one or more alphabetic characters. At block 316, the user is prompted to enter a DTMF character string associated with the alphabetic characters initially entered by voice by the user. At block 318, a yes/no grammar is loaded to allow the user to verify the DTMF character entry by speaking the words “yes or no.” The grammar also accepts other words with the same meaning, such as “correct”. At block 318, the DTMF character input by the user is played back to the user and at block 320 a determination is made as to whether the DTMF characters entered by the user are in fact the characters desired by the user. If not, the method proceeds back to block 314, and the user re-enters the DTMF characters until the DTMF characters entered by the user are correct.

Referring back to block 320, if the DTMF characters entered by the user are correct, the method proceeds to block 330, and the speech recognition engine 150 determines the number of character strings corresponding to the DTMF character input that sound like the original voice input entered by the user at block 308. For example, if the user originally entered by voice the characters “A,” “D,” and “E,” the speech recognition engine may have erroneously recognized the characters as “A,” “E,” and “C.” At blocks 314 through 320, the user may have entered the DTMF numbers “2,” “3,” and “3,” to verify the original alphabetic characters entered by voice by the user. At block 330, the speech recognition engine may determine that DTMF strings of “ADE,” “ADD,” “AEE,” and “AED” are potential DTMF character strings sounding like the original alphabetic character input and corresponding to the DTMF characters input by the user at block 314 through 320.

At block 334, if the speech recognition engine identifies only one DTMF character string, the method proceeds to block 336 and a yes/no grammar is loaded, and the user is prompted to verify that the string is correct. That is, the user is prompted to verify the one DTMF character string identified by the speech recognition engine 150 which sounds like the original alphabetic character input by the user. If only one DTMF character string is identified that sounds like the original voice alphabetic character input from the user and at block 338 this DTMF character string is verified as correct by the user, the method may end at block 395 where the DTMF character string identified by the speech recognition engine 150 is used as the correct character string requested from the user.

Referring back to block 334, if more than one DTMF character string is determined from the DTMF characters input by the user at block 330, the method proceeds to block 342, and the potential DTMF character strings and the alphabetic character input by the user are obtained by the speech recognition engine for further analysis. At block 346, the user is requested to repeat the voice alphabetic input, and at block 348 the speech recognition engine 150 receives the user's input.

At block 348, the speech recognition engine 150 performs recognition on the repeated voice alphabetic character input from the user and compares the repeated alphabetic input to the DTMF character strings and initial alphabetic character input to attempt to match the repeated alphabetic character input to a character input associated with one of the DTMF strings or to the initial alphabetic character input. That is, the speech recognition engine 150 attempts to determine whether the repeated voice alphabetic character input matches one of the DTMF character strings corresponding to the DTMF key entry performed by the user at blocks 314 through 320. If a matching entry is found, the entry is prompted to the user and at 352, a determination is made as to whether the user verifies that the alphabetic character string prompted to the user is correct. If so, the method ends at block 395 and the verified character string is utilized by the voice application 175. If the user does not verify the alphabetic character string presented to the user at block 350, or if the speech recognition engine is unable to isolate one character string by comparing the repeated voice alphabetic character string to the DTMF character strings, the method proceeds to block 354, and the user is sent to a human operator to assist the user in obtaining the correct alphabetic character string.

Referring back to block 312, if the initial input from the user was performed using keypad entry, such as DTMF character input, at block 310, the keypad character input is played back to the user for a determination as to whether the DTMF character input entered by the user is correct. As described above, DTMF and non-DTMF keypad entry may be utilized to enter alphabetic characters, and according to this embodiment, voice entered alphabetic characters may be used to augment a determination of the actual character string desired by the user. If the input played back to the user is correct, the method proceeds to block 342 for an analysis to determine a correct one of one or more potential alphabetic character strings associated with the DTMF numbers entered by the user. If the DTMF numbers entered by the user and played back to the user at block 310 are not correct, the method proceeds to block 322 where the DTMF grammar is loaded, if not already loaded. At block 324, the user is requested to re-enter the DTMF character string, and at block 326, the DTMF character string re-entered is played back to the user. At block 328, a determination is made as to whether DTMF character string entered by the user and played back to the user is correct. If not, the method proceeds back to block 322 and continues until the DTMF characters entered by the user are verified by the user.

Once the DTMF characters entered by the user are verified by the user, the method proceeds to block 342, as described above. At block 342, the speech recognition engine 150 determines the alphabetic character and phonetic alphabetic character combinations that correspond to the DTMF characters input by the user. That is, as described in detail above, depending on the DTMF characters input by the user, a number of different combinations of alphabetic characters may be presented. At block 346, the user is prompted to speak the alphabetic characters either by speaking the alphabetic characters or by speaking phonetic versions of the alphabetic characters.

At block 348, the alphabetic characters spoken by the user are received by the speech recognition engine, which in turn performs recognition on the voice input. At this time, the newly loaded grammar causes the speech recognition engine to expect one of the strings derived from the previous DTMF input. Because the acceptable grammar is narrowed, the ability of the speech recognition engine to accurately recognize the spoken alphabetic character input is increased. At block 352, the user is prompted to verify the identified character string as the correct character string. If the character string is incorrect, the method proceeds to block 354, and the user is sent to a human operator to assist the user in obtaining accurate alphabetic character string. If the character string is correct, the method ends at block 395, and the identified character string is utilized by the voice application 175.

Accordingly, if the user initially enters alphabetic characters as spoken alphabetic characters or phonetic versions of alphabetic characters, DTMF key entry from the user may be utilized to assist the speech recognition engine in accurately identifying the voice alphabetic character input from the user. On the other hand, if the user initially enters alphabetic characters via DTMF character entry, voice alphabetic character input from the user may be utilized to isolate one of one or more potential character strings associated with the DTMF character input received from the user.

As described herein, methods and systems are provided for improving alphabetic speech recognition accuracy using DTMF character input to assist a speech recognition engine in accurately recognizing alphabetic character input. It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

1. A method of improving alphabetic speech recognition by a speech recognition engine, comprising:
receiving a first spoken alphabetic character input from a user;
passing the first spoken alphabetic character input received from the user through a speech recognition engine;
at the speech recognition engine, recognizing the first spoken alphabetic character input received from the user;
querying the user for verification that the recognized alphabetic character input is the same as the first spoken alphabetic character input received from the user;
if the recognized alphabetic character input is not the same as the first spoken alphabetic character input received from the user, receiving from the user a dual tone multi-frequency (DTMF) key tone for each of one or more first spoken alphabetic characters received from the user; and
if one alphabetic character string associated with the DTMF key tones received from the user matches the first spoken alphabetic character input received from the user, designating the one alphabetic character string associated with the DTMF key tones received from the user that matches the first spoken alphabetic character input received from the user as a correct alphabetic character input.

2. The method of claim 1, prior to receiving a first spoken alphabetic character input from the user, prompting a user to enter by one or more spoken alphabetic characters; and
loading into the speech recognition engine a grammar definition defining a set of alphabetic characters acceptable to the speech recognition engine as responsive to the prompt to the user to enter by one or more alphabetic characters.

3. The method of claim 2, whereby the set of alphabetic characters includes the characters a, b, c, d, e, f, g, h, i, j, k, l, m, n, o, p, q, r, s, t, u, v, w, x, y, and z.

4. The method of claim 3, whereby the alphabetic character input received from the user includes one or more alphabetic characters from the set of alphabetic characters of claim 3.

5. The method of claim 4, whereby the set of alphabetic characters further includes phonetic versions of the alphabetic characters of claim 4.

6. The method of claim 5, whereby the alphabetic character input received from the user includes one or more alphabetic characters from the set of alphabetic characters of claim 5.

7. The method of claim 6, whereby the alphabetic character input received from the user includes one or more combinations of alphabetic characters from the set of alphabetic characters of claim 6.

8. The method of claim 2, whereby the set of alphabetic characters includes numerals associated with dual tone multi-frequency (DTMF) key tones from a telephone keypad.

9. The method of claim 8, whereby the alphabetic character input received from the user includes one or more DTMF key tones.

10. The method of claim 9, whereby numerals associated with DTMF key tones of a telephone keypad include 1, 2, 3, 4, 5, 6, 7, 8, 9.

11. The method of claim 10, whereby the set of alphabetic characters includes all alphabetic characters associated with the DTMF key tones.

12. The method of claim 1, prior to querying the user for verification that the recognized alphabetic character input is the same as the first spoken alphabetic character input received from the user, converting the recognized alphabetic character input from a digital format to an audio format.

13. The method of claim 12, whereby querying the user for verification that the recognized alphabetic character input is the same as the first spoken alphabetic character input received from the user includes presenting the audio formatted recognized character input to the user.

14. The method of claim 13, whereby the audio formatted recognized alphabetic character input is presented to the user telephonically.

15. The method of claim 1, prior to receiving from the user a DTMF key tone for each of the one or more spoken alphabetic characters input by the user:
prompting the user for a DTMF key tone for each of the one or more spoken alphabetic characters input by the user; and
querying the user to verify that the DTMF key tones received from the user are correct.

16. The method of claim 1, prior to designating the alphabetic character string associated with the DTMF key tones received from the user as a correct alphabetic character input requested from the user:
determining whether an alphabetic character string associated with the DTMF tones received from the user sounds like the first spoken alphabetic character input received from the user; and
querying the user to determine whether the alphabetic character string associated with the DTMF key tones received from the user match the first spoken alphabetic character input received from the user.

17. The method of claim 16, further comprising:
if more than one alphabetic character string is determined to be associated with the DTMF key tones received from the user that sound like the first spoken alphabetic character input received from the user,
receiving a second spoken input of the alphabetic character input from the user;
comparing the second spoken alphabetic character input received from the user to each of the more than one alphabetic character strings determined to be associated with the DTMF key tones received from the user that sound like the first spoken alphabetic character input received from the user; and
if the second spoken alphabetic character input received from the user matches one of the more than one alphabetic character strings determined to be associated with the DTMF key tones received from the user, designating the alphabetic character string associated with the DTMF key tones that matches the second spoken alphabetic character input received from the user as a correct alphabetic character.

18. A method of improving alphabetic speech recognition by a speech recognition engine, comprising:
receiving an alphabetic character input from a user via DTMF key tone selection;
determining one or more alphabetic character combinations that are represented by the DTMF key tone input received by the user;
receiving a first spoken alphabetic character input from the user by speech input;
passing the first spoken alphabetic character input received from the user through a speech recognition engine;
at the speech recognition engine, converting the first spoken alphabetic character input from an audio format to a digital format and recognizing the first spoken alphabetic character input received from the user; and
if the first spoken alphabetic character input received by the user matches one of the one or more alphabetic character combinations that are represented by the DTMF key tone input received from the user, designating the one of the one or more alphabetic character combinations that are represented by the DTMF key tone input received from the user that matches the first spoken alphabetic character input received from the user as a correct alphabetic character input.

19. The method of claim 18, whereby the alphabetic character combinations that are represented by the DTMF key tone input received from the user may include one or more phonetic versions of alphabetic characters that are represented by the DTMF key tone input received by the user.

20. A system for improving alphabetic speech recognition by a speech recognition engine, comprising:
a speech recognition engine operative to receive a first spoken alphabetic character input from a user;
to convert the first spoken alphabetic character input from an audio format to a digital format and to recognize the first spoken alphabetic character input received from the user;
to query the user for verification that the recognized alphabetic character input is the same as the first spoken alphabetic character input received from the user;
to receive from the user a dual tone multi-frequency (DTMF) key tone for each of one or more first spoken alphabetic characters received from the user, if the recognized alphabetic character input is not the same as the first spoken alphabetic character input received from the user; and
to designate the one alphabetic character string associated with the DTMF key tones received from the user that matches the first spoken alphabetic character input received from the user as a correct alphabetic character input if one alphabetic character string associated with the DTMF key tones received from the user matches the first spoken alphabetic character input received from the user.

21. The system of claim 20, prior to designating the alphabetic character string associated with the DTMF key tones received from the user as a correct alphabetic character input requested from the user, the speech recognition engine being further operative
to determine whether an alphabetic character string associated with the DTMF tones received from the user sounds like the first spoken alphabetic character input received from the user; and
to query the user to determine whether the alphabetic character string associated with the DTMF key tones received from the user match the first spoken alphabetic character input received from the user.

22. The system of claim 21, the speech recognition engine being further operative:
to receive a second spoken input of the alphabetic character input from the user if more than one alphabetic character string is determined to be associated with the DTMF key tones received from the user that sound like the first spoken alphabetic character input received from the user;
to compare the second spoken alphabetic character input received from the user to each of the more than one alphabetic character strings determined to be associated with the DTMF key tones received from the user that sound like the first spoken alphabetic character input received from the user; and
to designate the alphabetic character string associated with the DTMF key tones that matches the second spoken alphabetic character input received from the user as a correct alphabetic character if the second spoken alphabetic character input received from the user matches one of the more than one alphabetic character strings determined to be associated with the DTMF key tones received from the user.

23. A method of improving alphabetic speech recognition by a speech recognition engine, comprising:
receiving a first spoken alphabetic character input from a user;
passing the first spoken alphabetic character input received from the user through a speech recognition engine;
at the speech recognition engine, recognizing the first spoken alphabetic character input received from the user;
querying the user for verification that the recognized alphabetic character input is the same as the first spoken alphabetic character input received from the user;
if the recognized alphabetic character input is not the same as the first spoken alphabetic character input received from the user, receiving from the user a keypad entry for each of one or more first spoken alphabetic characters received from the user; and
if one alphabetic character string associated with the keypad entry received from the user matches the first spoken alphabetic character input received from the user, designating the one alphabetic character string associated with the keypad entry received from the user that matches the first spoken alphabetic character input received from the user as a correct alphabetic character input.
